(19) United States
(12) Patent Application Publication
(10) Pub. No.: US 2012/0066734 A1
(43) Pub. Date: Mar. 15, 2012

(54) SYSTEM AND METHOD FOR TRANSMITTING DATA CONTENTS

(76) Inventor: Kyoung Soo MOON, Seoul (KR)

(21) Appl. No.: 13/301,404

(22) Filed: Nov. 21, 2011

Related U.S. Application Data
(63) Continuation of application No. 10/329,796, filed on Dec. 27, 2002.

(30) Foreign Application Priority Data
Dec. 28, 2001 (KR) 87279/2001

(51) Int. Cl. H04N 21/40

(52) U.S. Cl. 725/110

(57) ABSTRACT

A method of controlling a display device, which includes receiving, via a receiver over the air, a broadcast program including audio and video data; receiving, via the receiver over the Internet, synchronization data including location data of additional contents data providing additional information about the broadcast program; reproducing, via a display of the display device, the received broadcast program including the audio and video data; receiving, via the controller, a selection signal indicating a request for the additional contents data while the broadcast program is being reproduced; extracting, via a controller of the display device, the location data from the received synchronization data; receiving, via the receiver over the Internet, the additional contents data identified by the location data; and displaying the received additional contents data on the display device.

This application is a Continuation of co-pending Application Ser. No. 10/329,796, filed on Dec. 27, 2002, the entire contents of which are hereby incorporated by reference and for which priority is claimed under 35 U.S.C. §120.

### BACKGROUND OF THE INVENTION

1. Field of the Invention

The present invention relates to a system and a method for transmitting data contents, and particularly, to a synchronization in data broadcasting.

2. Description of the Background Art

Generally, a data broadcasting is a kind of broadcasting which supplies additional data contents with broadcasting program from a broadcasting station, unlike the general broadcasting by which users should see only the programs broadcasted by the broadcasting station. And in the data broadcasting, a receiver and the broadcasting station interact with each other using the data contents, and the user of the receiver is able to obtain desired information in more detail.

That is, the data broadcasting is a two-way service providing the users with information required by the users from the broadcasting station so that the user can identify casts or historical background while watching a certain history program, and identify profiles of a singer or a sports player while watching TV show or sports program.

However, standards of the data broadcasting are different from countries, and are different from others even in a country. That is, focuses are audio contents and video contents of the broadcasting program, and to provide data contents related to the audio and video contents through an air. And the two-way service by which the broadcasting equipment and the receiver interact with each other is only suggested, and not practiced actually.

FIG. 1 is a view showing a service model of the data broadcasting according to the conventional art. As shown therein, the service model comprises a broadcasting device 100 for providing receivers of the users with produced broadcasting program and the data contents related to the program through the air 160 or through the internet 170, and receivers 180A, 180B, . . . , 180N receiving the broadcasting program and the data contents.

The broadcasting device 100 comprises: a broadcasting server 120 storing audio contents and video contents of the produced program and managing the contents; a data server 140 storing and managing predetermined data contents related to the program; a scheduler 110, in which programming information is stored, controlling input/output of the broadcasting server 120 and the data server 140 according to the programming information; and a broadcast transmitter 130 for transmitting the audio contents, the video contents and the data contents after combining the contents through the air 160 according to the scheduler 110.

Herein, the data contents can be varied according to international standards, generally the data contents are formed as Hyper Text Markup Language (HTML), Java script, image file, multimedia, hypermedia information coding expert group (MHEG) file and Java program.

Operations of the broadcasting service model configured as above according to the conventional art will be described as follows.

The broadcasting server 120 outputs predetermined audio contents and video contents corresponding to the programming information among the contents stored therein according to the programming information programmed in the scheduler of the broadcasting device 100, and the data server 140 outputs predetermined data contents corresponding to the programming information among the contents stored therein to the broadcast transmitter 130. Then, the broadcast transmitter 130 combines the audio contents, the video contents and the data contents appropriately, and transmits the contents through the air 160.

The transmitted audio contents, the video contents and the data contents are received through the receivers 180A, 180B, . . . , 180N such as a digital television receiver and a set-top box installed in respective houses and offices. Then, the receiver 180A, 180B, . . . , 180N displays the audio contents and the video contents, and displays the data contents as a certain signs after decoding the contents, and thereby, the user can identify that the data contents has received.

When the user chooses the data contents after identifying the receipt of the data contents by the signal displayed on the screen, the contents of the selected data are displayed on the screen of the receiver 180A, 180B, . . . , 180N. For example, in case that the user connects to the internet 170 using an internet browser on the receiver 180A, 180B, . . . , 180N and performs operations for getting information provided by the broadcasting device 100, the corresponding information according to the selection of the user is displayed on the screen of the browser.

At that time, the command of the user to the broadcasting device 100 can not be transmitted through the air 160 since the air is one-way communication. Therefore, the standard of the data broadcasting uses a communication media (for example, a telephone line or a cable) through which the two-way communication can be made so that the interaction between the receiver 180A, 180B, . . . , 180N and the broadcasting device 100 by communicating the data with each other.

In the standard of the data broadcasting, there is regulation only about the two-way communication media, however, details (especially, synchronizing information) are not decided. Therefore, the user who received the broadcasting program and the data contents through the air 160 can not obtain the data contents provided through the internet 160 timely.

### SUMMARY OF THE INVENTION

Therefore, an object of the present invention is to provide a system and a method suggesting a standard of two-way data broadcasting by classifying data contents into basic data and additional data and generating synchronizing information, and after that, transmitting basic data and synchronizing information through the air and providing additional data through internet.

Also, another object of the present invention is a system and a method for data broadcasting which provides various additional services according to individual requirements of users by making a two-way data broadcasting possible.

To achieve the objects of the present invention, as embodied and broadly described herein, there is provided a system for transmitting data contents comprising: a broadcasting server storing audio contents and video contents of produced broadcasting program and managing the contents; a data server for storing predetermined data contents related to the broadcasting program, classifying the data contents into basic data and additional data, generating synchronizing information according to timing dependencies of the basic data and of the additional data, and after that, transmitting the basic data and the synchronizing information and transmitting the additional data to a receiver through the internet; a scheduler, in which predetermined programming information is stored, for controlling input/output of the broadcasting server and the data server according to the programming information; and a broadcast transmitter for combining the audio contents, the video contents and the data contents according to the programming information of the scheduler and transmitting the contents through the air.

Also, to achieve the objects of the present invention, there is provided a method for transmitting data contents comprising: a step of classifying predetermined data contents into basic data and additional data; a step of generating synchronizing information according to timing dependency for each other of the basic data and the additional data; and a step of transmitting the corresponding basic data and synchronizing information through the air according to programming information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a data broadcasting service model according to the conventional art;

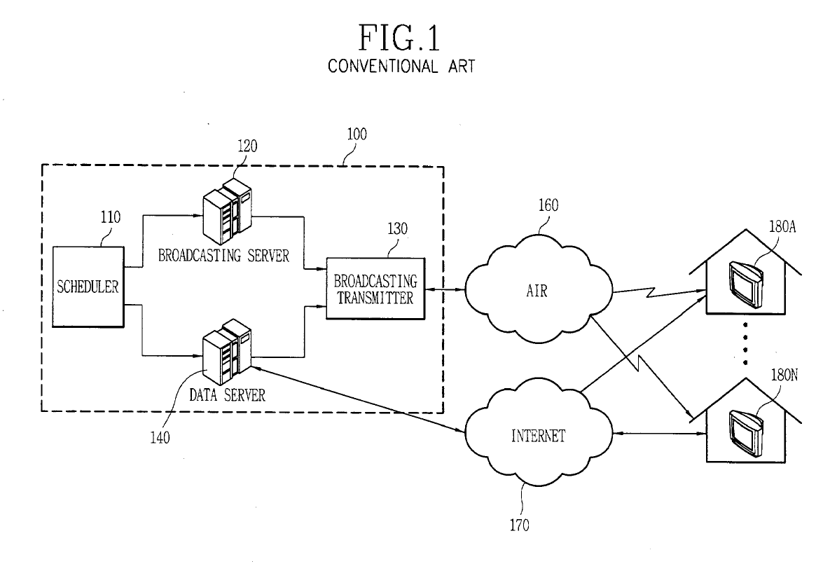

FIG. 2 is a view showing a data broadcasting service model according to the present invention;

FIG. 3 is a block diagram showing a data server shown in FIG. 2; and

FIG. 4 is a flow chart illustrating operations of the data broadcasting service model according to the present invention.

### DETAILED DESCRIPTION OF THE PREFERRED EMBODIMENTS

Reference will now be made in detail to the preferred embodiments of the present invention, examples of which are illustrated in the accompanying drawings.

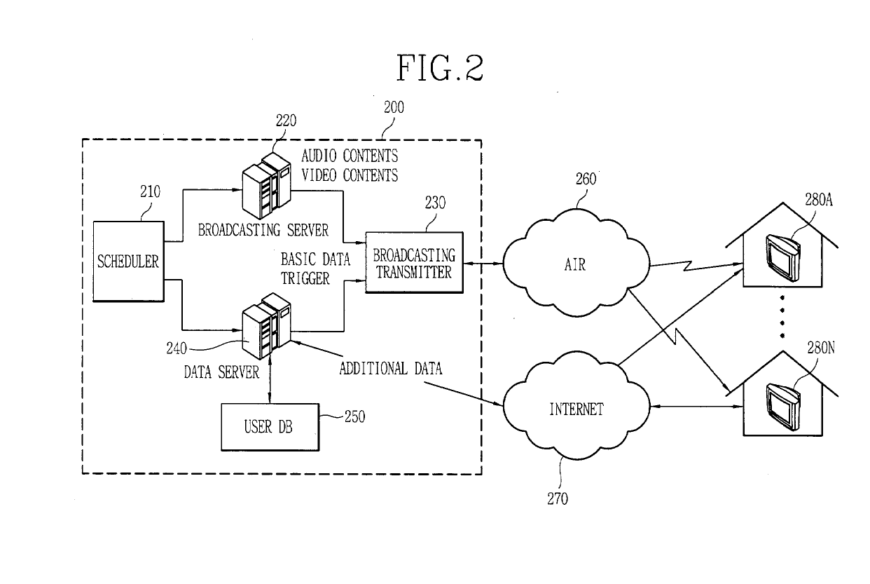

FIG. 2 is a view showing a data broadcasting service model according to the present invention. As shown therein, the service model comprises: a broadcasting device 200 for providing receivers 280A, 280B, . . . , 280N of users with a produced broadcasting program and data contents related to the program through the air 260 or through internet 270; and receivers 280A, 280B, . . . , 280N for receiving the broadcasting program and the data contents.

The broadcasting device 200 comprises: a broadcasting server 220 for storing audio contents and video contents of the produced program and managing the contents; a data server 240 for storing and managing predetermined data contents related to the program; a user database 250 for storing information such as tastes of users; a scheduler 210, in which broadcasting programming information is stored, for controlling input/output of the broadcasting server 220 and the data server 240 according to the programming information; and a broadcast transmitter 230 for combining the audio contents, video contents and the data contents according to the scheduler 210 and transmitting the contents through the air 260.

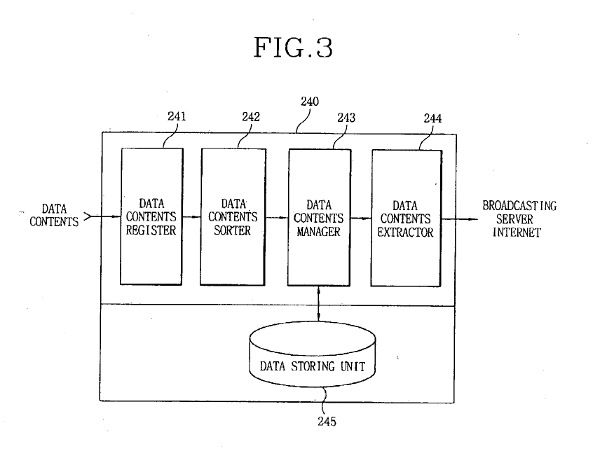

FIG. 3 is a block diagram showing the data server shown in FIG. 2. As shown therein, the data server 240 comprises: a data contents register 241 for registering the data contents which are produced for data broadcasting; a data contents sorter 242 for classifying the registered data contents into the basic data and the additional data and generating synchronizing information according to broadcasting timing dependencies of the basic data and the additional data; a data contents manager 243 for storing the synchronizing information in a data storing unit 245 and reading the information; and a data contents extractor 244 transmitting the basic data and the synchronizing information through the broadcast transmitter 230 and the air 260 according to the programming information of the scheduler, and reading the additional data from the data storing unit 245 and providing the receiver 280A, 280B, . . . , 280N with the data through the internet 270 in case that the receiver 280A, 280B, . . . , 280N connects to the broadcasting device 200 through the internet 270 using the synchronizing information.

Herein, the data contents sorter 242 classifies a file in the registered data contents (generally comprising a plurality of files), which will be shown to the user of the receiver 280A, 280B, . . . , 280N at first, as the basic data, and classifies other files besides the above file as the additional data. At that time, the classification of the basic data and the additional data is completed, the data contents sorter 242 generates the synchronizing information by deciding timing dependencies of the basic data and the additional data. At that time, the synchronizing information includes information about a location where the additional data files are stored and broadcasting time information.

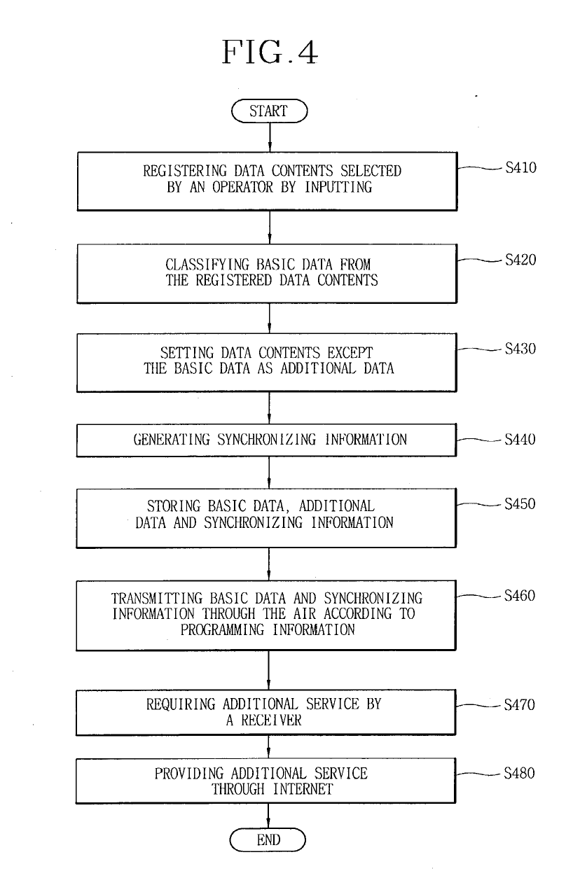

Transmitting operation of the data broadcasting service model according to the present invention will be described as follows with reference to FIG. 4.

The broadcasting server 220 outputs corresponding audio contents and the video contents among the contents stored therein to the broadcast transmitter 230 according to the broadcasting programming information in the scheduler of the broadcasting device 200. In addition, the data server 240 outputs the corresponding data contents among the data contents stored therein to the broadcast transmitter 230. Then, the broadcast transmitter 230 combines the audio contents, the video contents and the data contents appropriately, and transmits the contents through the air 260.

That is, when the data contents register 241 of the data server 240 registers the data contents produced for broadcasting in itself, the data contents sorter 242 classifies the basic data from the registered data contents. At that time, the data contents sorter 242 classifies the file which will be shown to the users at first among those the content files as the basic data (S410 and S420).

When the classification of the basic data is completed, the data contents sorter 242 classifies other data besides the classified basic data as the additional data, and generates the synchronizing information according to the timing dependencies of the basic data and the additional data. At that time, the synchronizing information includes the broadcasting times of the programs (that is, the basic data and the additional data) decided by the scheduler, and location information of the additional data in the data server for the programs (S430 and S440).

After that, the classified basic data, the additional data and the synchronizing information are stored in the data storing unit 245 by the data contents manager 243 (S450). Then, the data contents extractor 244 extracts predetermined basic data and the synchronizing information from the data storing unit 245 through the data contents manager 243 according to the programming information of the scheduler, and transmits the extracted basic data and the synchronizing information to the air 260 through the broadcast transmitter 230 (S460).

After that, operations of the data broadcasting service model after the receiver 280A, 280B, . . . , 280N receives the basic data and the synchronizing information will be described as follows.

The transmitted audio contents, the video contents and the data contents are received by the receiver 280A, 280B, . . . , 280N such as a digital television receiver and a set-top box installed on respective houses and offices. Then, the receiver 280A, 280B, . . . , 280N displays the audio contents and the video contents, and after that, notifies the user of the data contents receipt by decoding and displaying the data contents on the screen as a signal.

When the user identifies the receipt of data contents by the signal displayed on the screen and selects the data contents through the signal, the receiver 280A, 280B, . . . , 280N connects to the broadcasting device 200 through the internet 270 using the transmitted synchronizing information to require the additional data (S470). Then, the data contents extractor 244 of the data server 240 extracts the additional data corresponding to the location information included in the synchronizing information from the data storing unit 245, and supplies the data to the receiver 280A, 280B, . . . , 280N through the internet 270 (S480).

That is, the synchronizing information includes broadcasting times of the programs (basic data and additional data) decided by the scheduler, and includes location information of the additional data in the data server 240 for the programs which will be broadcasted. Therefore, the receiver 280A, 280B, . . . , 280N is able to know the storing location of the additional data for the broadcasting program in the data server 240, and when the user requires the additional data, the additional data can be displayed on the screen promptly. The timing information and the additional data are very useful when different additional services are provided to users.

As described above, in the data broadcasting service model, an advanced television enhanced forum (ATVEF) will be described as follows among the standards for transmitting the synchronizing information of respective countries.

The data contents in the ATVEF is the HTML, image or sound. Also, there is the HTML having timing interrelation among those HTML, image or sound. Therefore, according to the programming time of the broadcasting programs which will be shown to the users by being displayed on the screen of the receiver 280A, the data contents transmitted through the air 260 are synchronized using the timing information of the HTML as the synchronizing information. The synchronizing information includes the broadcasting time and function name of a Java script which will be performed, and therefore, the receiver 280A executes the corresponding Java script at the time defined by the synchronizing information. After that, the receiver 280A performs the functions according to the Java script function, and after that, receives the additional data according to the requirement of the user from the broadcasting device 200 through the internet 270.

Also, in case of applying the present invention to a personalization, common contents which will be transmitted to all users are transmitted through the air 260, and information according to the users' tastes is stored in the user database 250 as constructing the information into groups and provided through the internet 270. Therefore, the user is able to watch the information suitable for the user's taste selectively. That is, if the function of the Java script of the synchronizing information transmitted through the air 260 is “viewFavorite( )”, the receiver 280A executes the above function at the set time (since the synchronizing information includes broadcasting time information). After that, the receiver 280A requires the additional data according to the selection of the user (the additional data according to the user's taste) to the broadcasting device 200 and receives the data through the internet 270.

As described above, the present invention classifies the data contents into the basic data and the additional data and generates the synchronizing information, and transmits the basic data and the synchronizing information through the air and provides the additional data through the internet to suggest a standard for the two-way data broadcasting.

Also, according to the present invention, the two-way data broadcasting can be made and various additional services can be provided according to the individual needs of the users.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method of controlling a display device, the method comprising:
receiving, via a receiver over the air, a broadcast program including audio and video data;
receiving, via the receiver over the Internet, synchronization data including location data of additional contents data providing additional information about the broadcast program;
reproducing, via a display of the display device, the received broadcast program including the audio and video data;
receiving, via the controller, a selection signal indicating a request for the additional contents data while the broadcast program is being reproduced;
extracting, via a controller of the display device, the location data from the received synchronization data;
receiving, via the receiver over the Internet, the additional contents data identified by the location data; and
displaying the received additional contents data on the display device.

2. The method of claim 1, further comprising:
before receiving the additional contents data, classifying data associated with the broadcast program into basic data and the additional contents data.

3. The method of claim 2, wherein the basic data is data that is to be first shown to a user watching the broadcast program and the additional contents data is all other data that is not the basic data.

4. The method of claim 3, wherein the synchronization data further includes information indicating timing dependencies of the basic data and the additional contents data with respect to the broadcast program.

5. The method of claim 1, wherein the location data identifies a location of a data server providing the additional contents.

6. The method of claim 1, further comprising:
displaying an indicator on the display indicating the additional contents data.

7. The method of claim 6, wherein the indicator displays a first color indicating the additional contents is available and a second color indicating the additional contents is not available.

8. The method of claim 7, wherein the additional contents is received and displayed when a user selects the indicator displaying the first color.

9. The method of claim 1, wherein the additional contents data and the broadcast program are received independently from each other.

10. The method of claim 1, wherein the receiving step receives the broadcast program over the air via a broadcast server, and receives the additional contents data over the Internet via a data server.

11. A display device, comprising:
a receiver configured to receive over the air, a broadcast program including audio and video data, and to receive over the Internet, synchronization data including location data of additional contents data providing additional information about the broadcast program;
a display configured to display the received broadcast program including the audio and video data; and
a controller configured to receive a selection signal indicating a request for the additional contents data while the broadcast program is being reproduced, to extract the location data from the received synchronization data, to control the receiver to receive over the Internet, the additional contents data identified by the location data, and to control the display to display the received the additional contents data.

12. The display device of claim 11, further comprising:
before receiving the additional contents data, data associated with the broadcast program is classified into basic data and the additional contents data.

13. The display device of claim 12, wherein the basic data is data that is to be first shown to a user watching the broadcast program and the additional contents data is all other data that is not the basic data.

14. The display device of claim 13, wherein the synchronization data further includes information indicating timing dependencies of the basic data and the additional contents data with respect to the broadcast program.

15. The display device of claim 11, wherein the location data includes identifies a location of a data server providing the additional contents.

16. The display device of claim 11, wherein the controller is further configured to control the display unit to display an indicator on the display indicating the additional contents data.

17. The display device of claim 16, wherein the indicator displays a first color indicating the additional contents is available and a second color indicating the additional contents is not available.

18. The display device of claim 17, wherein the additional contents is received and displayed when a user selects the indicator displaying the first color.

19. The display device of claim 11, wherein the additional contents data and the broadcast program are received independently from each other.

20. The display device of claim 11, wherein the receiver receives the broadcast program over the air via a broadcast server, and receives the additional contents data over the Internet via a data server.
